(19) United States
(12) Patent Application Publication
(10) Pub. No.: US 2011/0017151 A1
(43) Pub. Date: Jan. 27, 2011

(54) Wound care system for pets

(76) Inventor: Jacquelyn Simoni, Glen Ellyn, IL (US)

Correspondence Address: Erickson Law Group, PC, 1749 S. NAPERVILLE ROAD, SUITE 202, WHEATON, IL, 60189, US

(21) Appl. No.: 12/841,711

(22) Filed: Jul. 22, 2010

Related U.S. Application Data
(60) Provisional application No. 61/228,268, filed on Jul. 24, 2009.

(51) Int. Cl. A01K 13/00

(52) U.S. Cl. 119/850

(57) ABSTRACT

A wound protection system which utilizes a tubular sheath to provide coverage over an animal's injured limb. An adjustable strap extends from the tubular sheath to allow the strap to be adjusted to fit on animals of various sizes. The adjustable strap engages with the animal's collar to prevent the tubular sheath from riding down the animal's leg. The tubular sheath may have a rubber and/or water resistant region at the region of the tubular sheath in contact with an animal's paw. An interlocking mechanism along the adjustable strap allows for ease of removing the wound protection system. The tubular sheath may be equipped with additional padding, reinforcing ribs, non-stretchable strip, height adjustment mechanism, and/or a fitted region to provide various benefits to the animal.

This invention claims the benefit of U.S. Provisional Application 61/228,268 filed on Jul. 24, 2009.

### FIELD OF THE INVENTION

This invention relates in general to wound protection systems for animals, in particular wound protection system for pets.

### BACKGROUND OF THE INVENTION

Animals that are injured often have their wounds bandaged pending the healing of the wound. Often, because of the irritation of the bandage or due to their natural desire to lick their wounds, animals are prone to licking, pawing, biting, or otherwise making undesirable contact with their bandaged wound. An animal may easily pull the bandage down and off its legs. Undesirable contact can have detrimental effects on the natural healing process, in particular if the licking or pawing exposes the wound to bacteria which can cause an infection.

One method of preventing an animal from accessing their wound is through the use of a cone collar. Cone collars are cone shaped structures which are attached onto the animal's neck to prevent the animal from reaching its wounds. Cone collars are cumbersome, and frequently obstruct a pet's peripheral view. Due to the weight of the cone collar on an animal's neck region and the obstruction of view, cone collars greatly reduce an animal's mobility during the animal's healing period. Cone collars also do not protect the bandaged wound from contamination from dirt or from getting the bandage wet.

Various wound protection systems comprise a tubular member which is disposed over the bandaged wound and shields the wound. However, such wound protection systems are not practical because such systems may be prone to slipping off the bandage, or crumpling such that portions of the bandaged wound are exposed. The owner then has to check the wound protection system regularly to ensure that the tubular shield is covering the bandaged wound properly. Some prior art wound systems do not provide sufficient reinforcing mechanisms such that the animal is still able to damage the bandage despite the bandage being shielded.

The present inventor has recognized the need for an animal wound protection system that is easy to use and does not have any of the disadvantages of prior art wound protection systems.

The present inventor has recognized the need for a more effective wound protection system that does not restrict an animal's mobility or interfere with their activity.

The present inventor has recognized the need for an easily adjustable wound protection system that can be adapted for use on animals of various shapes and sizes.

The present inventor has recognized the need for a wound protection system which prevents the animal from pulling the bandage off in addition to preventing the animal from licking the bandage.

### SUMMARY OF THE INVENTION

The present invention provides a wound protection system comprising a tubular sheath and an adjustable strap. The tubular sheath can extend to, and cover an animal's paw. The adjustable strap extends from the tubular sheath to allow the strap to be adjusted to fit on animals of various sizes. The adjustable strap contains a length adjusting mechanism, and engages with the collar such that the tubular sheath will not fall off the animal. In an alternate embodiment, the adjustable strap is a sling which passes under the animal's collar and is strapped around an animal's back or neck region.

In an alternate embodiment, a fitted region may be present at the base of the tubular sheath, and above the paw of the animal to prevent the tubular sheath from riding down the leg of the animal and interfering with the animal's mobility. The tubular sheath may comprise a protective region at the animal's paw which provides properties such as water resistance, or enhanced traction.

In another embodiment, the tubular sheath may comprise reinforcing ribs along the interior surface of the tubular sheath to prevent the tubular sheath from riding up the animal's leg when the tubular sheath does not extend to, and encompass the animal's paw. The tubular sheath may contain a lengthwise non-stretchable strip on the inner surface of the tubular sheath to prevent the sheath from riding down. The tubular sheath my also comprise pockets or sleeves to receive padding inserts or other types of inserts such as an ice or heat compress to achieve the desired wound healing dynamics. In an alternate embodiment, the tubular sheath comprises a height adjustment mechanism which allows the height of the tubular sheath to be adjusted to suit the height of the animal's limbs. It is preferable for the tubular sheath to cover up to the animal's limbs to prevent the animal from bending its leg to extract the leg from a too-short tubular sheath.

In one embodiment, the wound protection system can protect two of the animals limbs simultaneously by connecting the tubular sheaths to an adjustable strap on an animal's back. In another embodiment, all four of an animal's limbs may be simultaneously covered by the wound protection system.

The wound protection system can also to be used to prevent animal injury or discomfort. The wound protection system can be used to shield the animal's limb from contact with mud or salt, or other undesirable environmental factors.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 illustrates a side view of exemplary embodiments of the wound protection system.

FIG. 2 illustrates a side view of another exemplary embodiment of the wound protection system.

FIG. 3 illustrates a side view of an alternate embodiment of the wound protection system.

FIG. 4 illustrates a perspective view of the embodiment illustrated in FIG. 3.

FIG. 5 illustrates an alternative embodiment of the wound protection system with a fitted region.

FIG. 5A illustrates an alternate embodiment of the wound protection system with a tubular sheath which extends to the fitted region.

FIG. 5B illustrates an alternate embodiment of the wound protection system with a non-stretch strip along the inner surface of the tubular sheath.

FIG. 5C illustrates the embodiment of FIG. 5B with a second adjustment mechanism and the non-stretch strip not shown for clarity.

FIG. 6 illustrates an alternate embodiment of the wound protection system with a padding option.

FIG. 6A illustrates a padding insert for use with the embodiment of the wound protection system of FIG. 6.

FIG. 7 illustrates an alternate embodiment of the wound protection system for an animal's back legs.

FIG. 8 illustrates an alternate embodiment of the wound protection system which can be used to simultaneously protect all four of an animal's limbs.

FIG. 8A illustrates an alternate embodiment of the wound protection system with a loop for attaching the wound protection system of FIG. 8 to an animal's collar.

FIG. 9 illustrates an alternate embodiment of the wound protection system which can be used to simultaneously protect the front limbs.

### DETAILED DESCRIPTION OF THE PREFERRED EMBODIMENTS

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

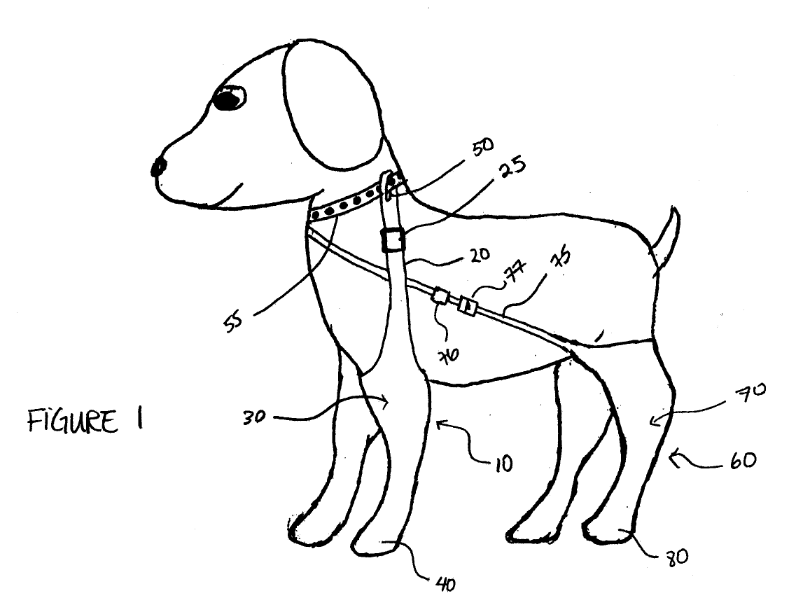

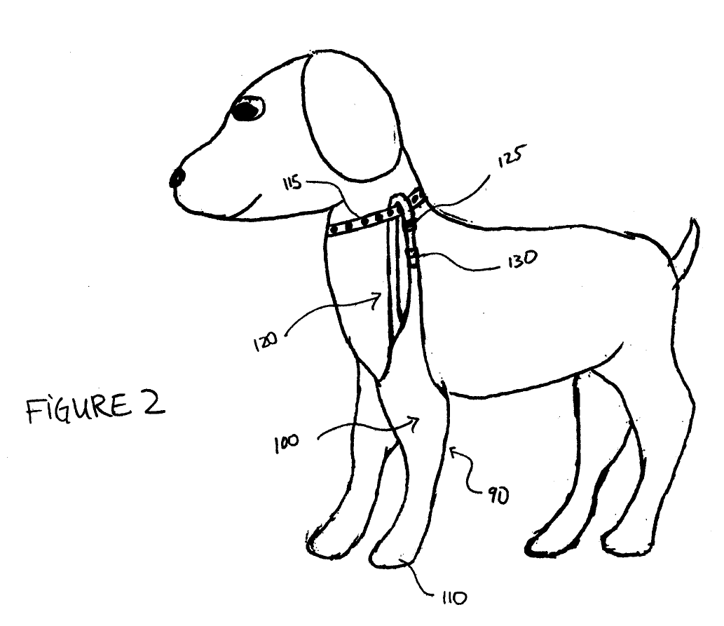

FIG. 1 illustrates an exemplary embodiment of the wound protection system on a dog. The wound protection system 10 comprises a tubular sheath 30 which extends to, and covers an animal's paw at the paw region 40. An adjustable strap 20 extends from the tubular sheath 30. The distal end of the adjustable strap comprises a loop 50 through which a collar 55 can be passed to secure the tubular sheath 30 to the collar 55 such that the tubular sheath will not fall off the animal. The adjustable strap 20 contains a length adjusting mechanism 25 for adjusting the length of the strap to allow the wound protection system to be used for animals of different sizes. Length adjustment of the strap can be achieved using a length adjusting loop, a belt, VELCRO fastener, or any other suitable mechanism known to one skilled in the art. The wound protection system can be worn by itself or over a bandage.

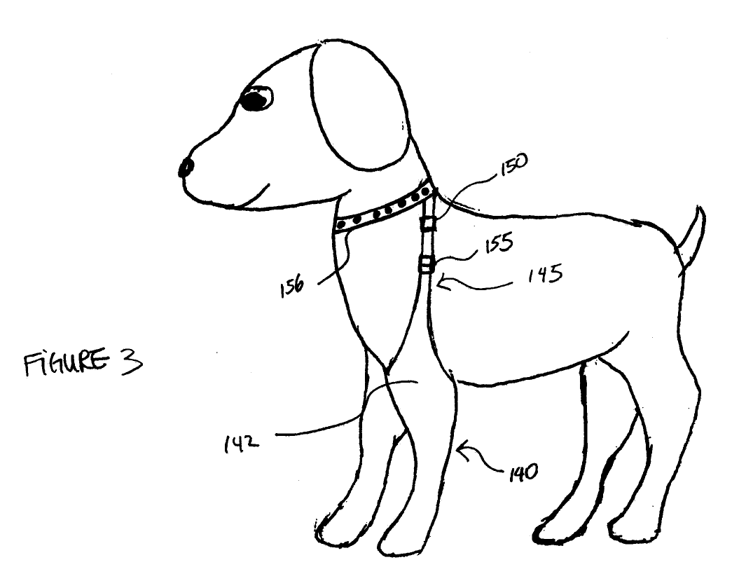

FIG. 2 illustrates an alternate embodiment of the wound protection system. The wound protection system 90 comprises a tubular sheath 100 which extends to, and covers an animal's paw at the paw region 110. An adjustable strap 120 is a loop which allows the strap to be wrapped around the collar 115. The adjustable strap 120 comprises a length adjusting mechanism 125 as described above, and an interlocking mechanism 130 for connecting two ends of the adjustable strap 120. The interlocking mechanism 130 can be a snap buckle, a hook, a VELCRO fastener, or any other suitable mechanism known to one skilled in the art. The interlocking mechanism 130 allows for ease of removability of the wound protecting system.

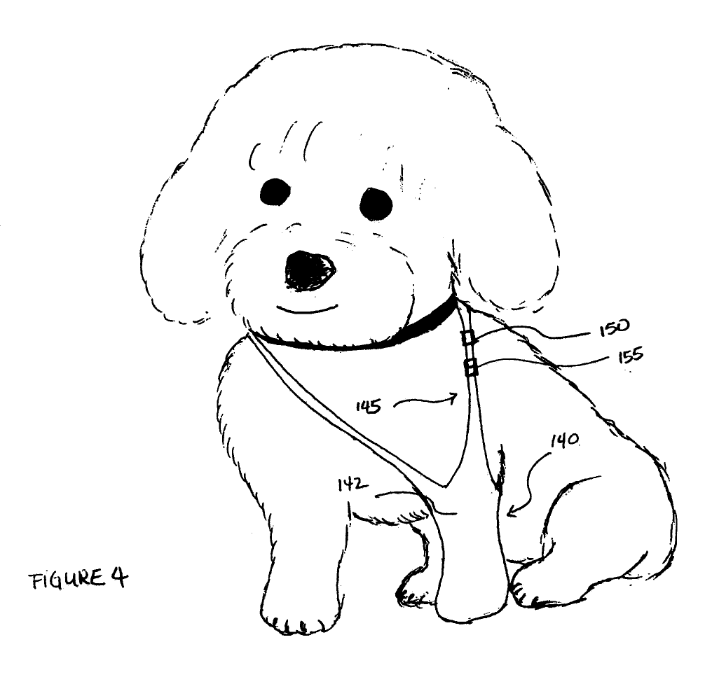

FIGS. 3 and 4 illustrate yet another embodiment of the wound protection system. The wound protection system 140 comprises a tubular sheath 142 which extends to, and covers an animal's paw. An adjustable strap 145 acts as a sling which is strapped around an animal's back or neck region (FIG. 4). The strap 145 is preferably tucked under the collar 156 as it crosses the animal's back. The adjustable strap 145 comprises a length adjusting mechanism 150 and an interlocking mechanism 155 as described above.

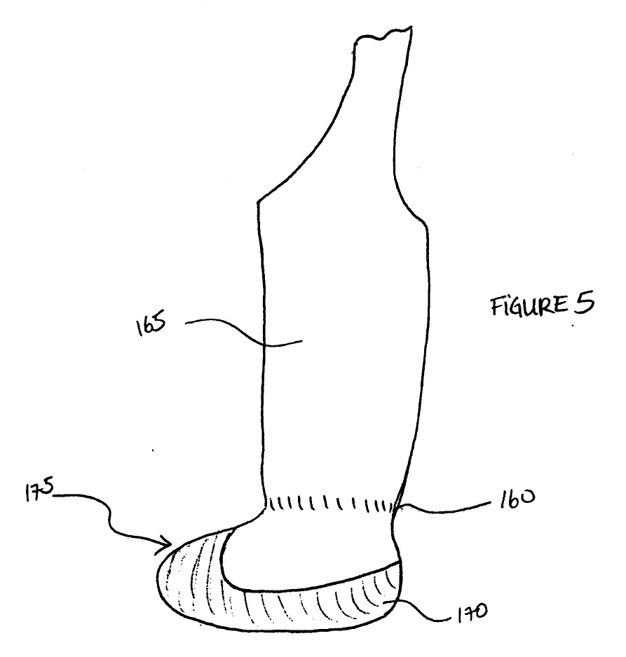

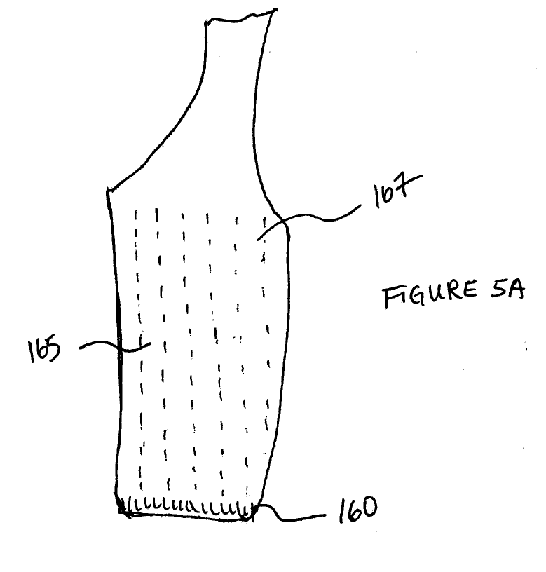

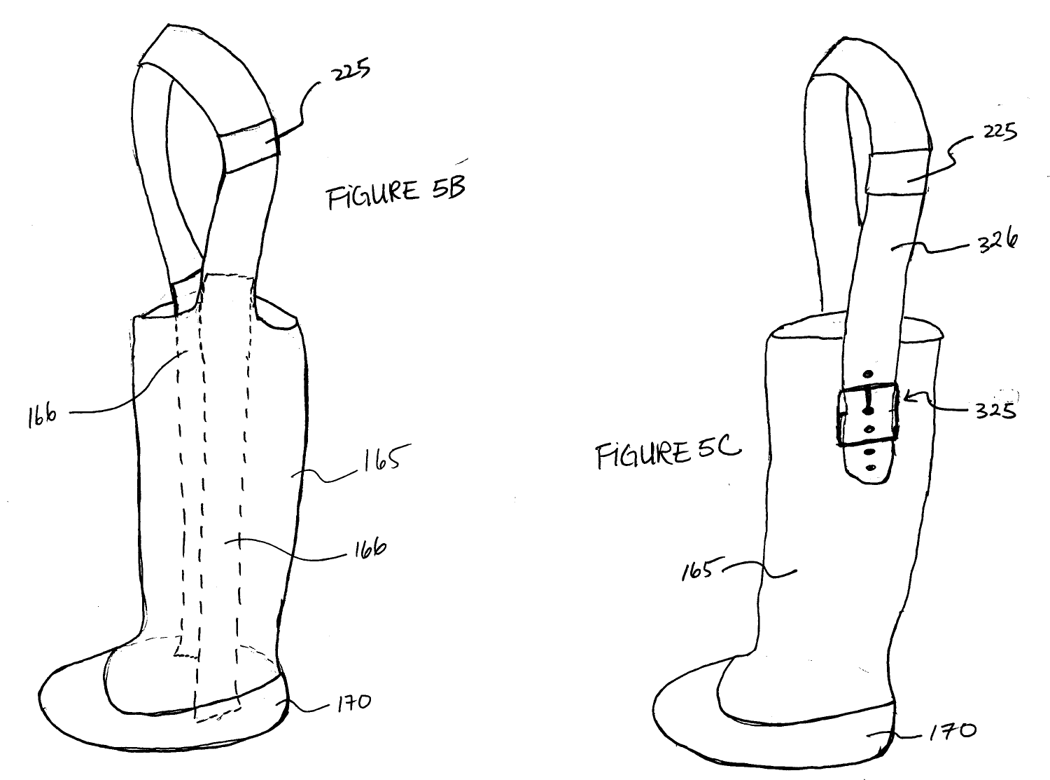

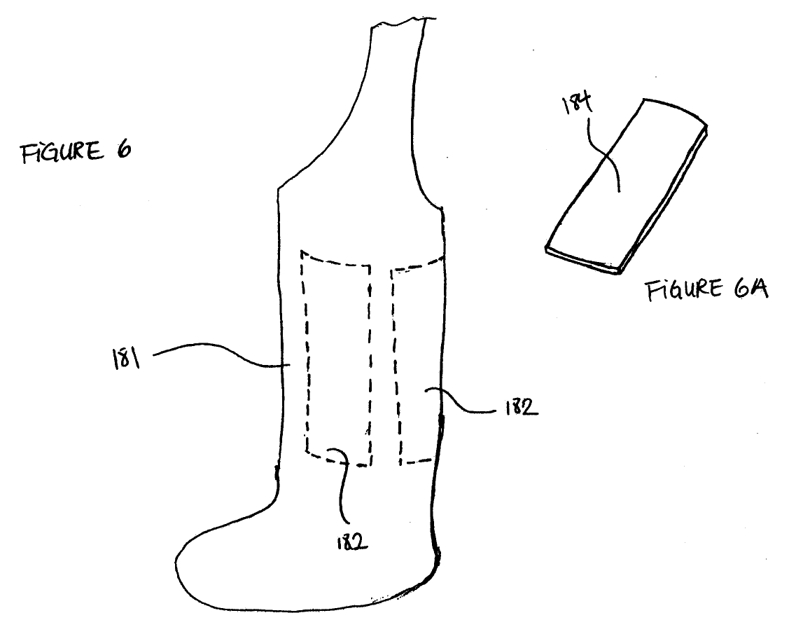

FIG. 5 illustrates an embodiment of the wound protection system comprising a fitted region 160 at the base of the tubular sheath 165, and above the paw region 175. The fitted region allows for a better fit of the tubular sheath 165 at the paw region 175 to enhance an animal's comfort, particularly when the animal walks or runs. The paw region 175 can further comprise a protective region 170. The protective region 170 may be a layer of a different material in the tubular sheath at the paw region, which allows the protective region to be resistant to water. The protective region 170 may also provide more traction to the animal, as the animal's wounded leg may be weaker.

The fitted region 160 can be a gathered elastic fitting along the circumference of the tubular sheath 165, a drawstring mechanism, a VELCRO strap, a buckle, or any other mechanism which allows the tubular sheath to decrease in diameter for a closer fit with the animal's leg. The fitted region 160 prevents the tubular sheath from riding down in the event the tubular sheath may be slightly longer than the limb of the animal.

The protective region 170 can be made of rubber, silicone, polymeric materials or blends, or a combination thereof. The protective region 170 can also provide mechanical traction by having small protrusions (not shown) on the surface of the protective region. The protective region 170 can be made of water resistant material such that in wet environments, the animal's paw does not get wet. Traction provided by the protective region 170 can also prevent the animal from slipping on slippery surfaces. Preferably, the protective region 170 rises from the bottom of the animals paw to extend over the top of the animal's nails to minimize the risk of the toenails breaking through the material of the wound protection system. In embodiments without the protective region 170, appropriate material is used to ensure durability of the wound protection system at the toenail region.

In another embodiment, the tubular sheath 165 does not extend to the animal's paw or cover the paw, but rather terminates at the ankle of the animal. The fitted portion 160 is beneficial to prevent the bottom of the tubular sheath 165 from riding up the animal's leg. The tubular sheath 165 may further comprise reinforcing ribs 167 along the interior surface of the tubular sheath 165. The reinforcing ribs 167 prevent the tubular sheath from riding up on the leg of the animal. The reinforcing ribs 167 can be used in conjunction with, or instead of, the fitted portion 160 and can also be used even when the tubular sheath extends to, and encompasses an animal's paw. The reinforcing ribs 167 may be disposed on the exterior surface of the tubular sheath. The reinforcing ribs 167 may be made by sewing more material together to create a rib, may be a rod insert sewn between two panels of fabric, or may be inserted and removed from sleeves along a portion of the length of the tubular sheath. Such rod inserts can also be used as splints to limit the movement of the limb.

In one embodiment, the tubular sheath 165 comprises a non-stretch strip 166. As illustrated in FIG. 5B, a pair of non-stretch strips 166 are disposed diametrically opposed on the inner surface of the tubular sheath 167. More than a pair of non-stretch strips 166 may be used within the inner surface of the tubular sheath. The non-stretch strips 166 prevent the tubular sheath 167 from sliding down an animal's limb. The non-stretch strips are placed along the inner surface of the tubular sheath 167 rather than on the exterior surface to prevent an animal from chewing it or tearing it off. The non-stretch strips can be made with materials which exhibit little or no elastic properties in either direction. The tubular sheath 165 is connected to a strap with an adjustment mechanism 225, as described in embodiments above. The non-stretch strips are preferably attached to the strap as illustrated in FIG. 5B so that the legging can be pulled up.

FIG. 5C illustrates the embodiment of FIG. 5B with an additional adjustment mechanism 325. The height adjustment mechanism 325 allows for the tubular sheath to be adjusted to suit the length of the leg of the animal. The tubular sheath should go to the top of the animal's limb to prevent the animal from disengaging its limb from the tubular sheath. If the sheath is too short, an animal may be able to bend its leg and disengage its limb from the tubular sheath. To ensure a proper fit, the tubular sheath may be of different sizes to suit various types and sizes of animals. A proper fit increases an animal's comfort and minimizes the likelihood that an animal would try to remove the tubular sheath. To provide a proper fit, the legging, in addition to being of appropriate size, is height adjustable, via height adjustment mechanism 325. The height adjustment mechanism is connected to the strap 326. The height adjustment mechanism can be any type of suitable mechanism, including snap fit mechanisms, buttons, and the like, which engage with sufficient capacity such that an animal is not prone to disengaging the mechanism. The height adjustment mechanism may be a buckle as illustrated in FIG. 5C.

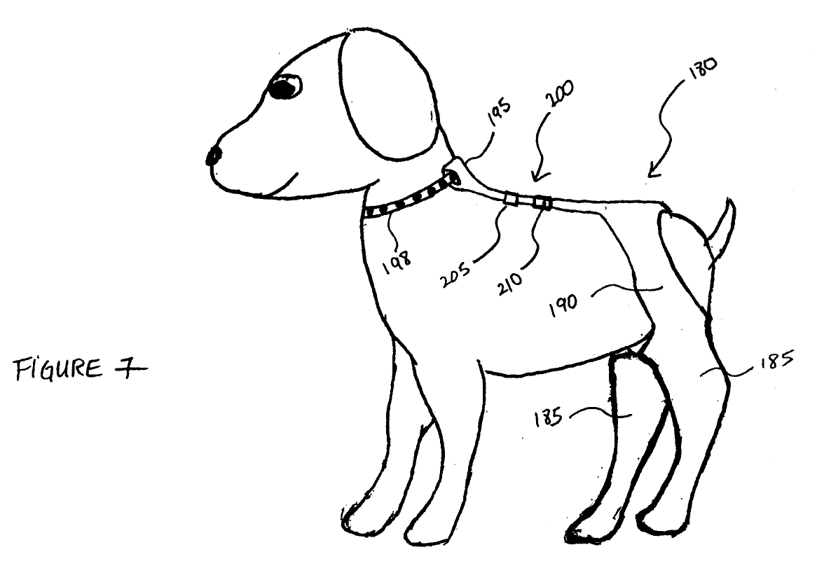

In an alternate embodiment, as illustrated in FIG. 6, the tubular sheath 181 may comprise pockets or sleeves 182 on the interior surface of the tubular sheath. The pockets 182 are shaped to receive complementary shaped padding inserts 184 which can be slipped within the pockets to provide additional padding to insulate the bandaged wound. Additional padding can also be use to provide support for an animal's limb if the limb is weakened due to injury. Stiffer padding material can also be used as a splint to prevent undesirable movement of an animal's limb which can hamper recovery. The padding inserts 184 can be of any shape or size. For example, the padding inserts may be annular, instead of columnar as illustrated. The padding inserts 184 can be made of any suitable material to impart the desired degree of stiffness or softness to the padding. The padding inserts can be made from foam. Inserts received in the pockets 182 need not be limited to only padding. Other types of insert, such as those providing an ice or heat compress, can also be inserted into the pockets to achieve the desired wound healing dynamic. Such padding on the interior surface of the tubular sheath can also be used to put pressure on the limb by selecting and positioning padding inserts of the desired shaped within the pockets 182. In other embodiments, pockets 182 may be on the exterior surface of the tubular sheath to provide padding from the exterior.

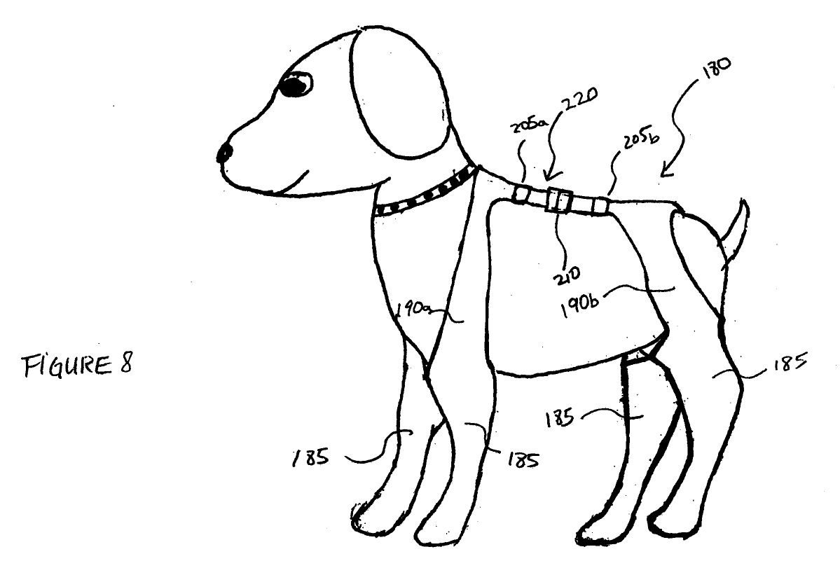

The wound protection system can also be used on an animal's hind limbs, as illustrated in FIGS. 1 and 7. FIG. 1 illustrates a wound protection system 60 comprising a tubular sheath 70 which extends to, and covers the paw at a paw region 80. The wound protection system comprises an adjustable strap 75 with a length adjusting mechanism 76 and an interlocking mechanism 77 to connect two ends of the adjustable strap 75. The adjustable strap 75 extends from either side of the tubular sheath 70. The length adjusting mechanism 76 and an interlocking mechanism 77 can be such as described above. The adjustable strap 75 extends across the front chest region of the animal in a sling-like manner, and encircles the animal towards the back of the animal and in between the hind legs on the other side (not visible) of the tubular sheath 70. The adjustable strap 75 preferably passes under the collar 55 to ensure that the animal does not remove the tubular sheath.

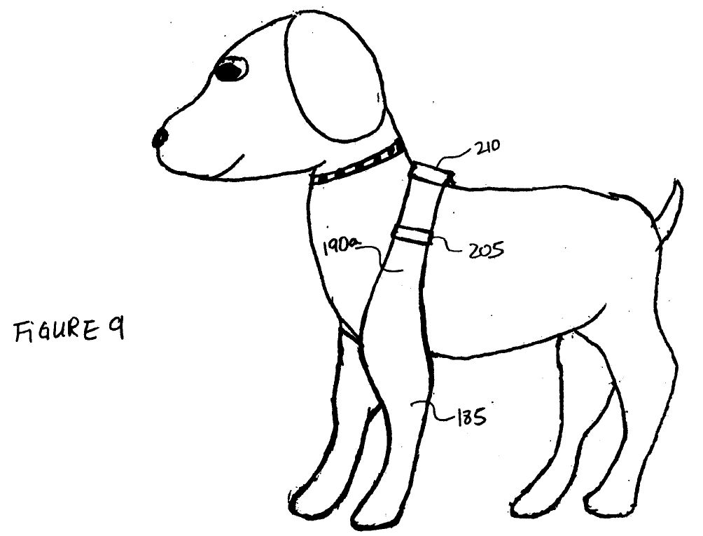

FIG. 7 illustrates a wound protection system which can cover two limbs simultaneously. The wound protection system 180 comprises mirror image tubular sheaths 185 for opposing limbs on an animal. Tubular sheaths 185 extend towards the paw and enclose the paw. Tubular sheaths 185 have side straps 190 that extend from the top of the tubular sheath 185 toward the animal's back to converge with the opposing side wall such that the side straps 190 can merge with an adjustable strap 200 along the animal's back. The adjustable strap 200 comprises a loop 195 through which the collar 198 can pass to secure the adjustable strap 200 to the collar 198. The adjustable strap 200 comprises a length adjusting mechanism 205 and an interlocking mechanism 210. The length adjusting mechanism 205 and the interlocking mechanism 210 can be as previously described above. The wound protection system 180 can also be used for the front legs by shortening the adjustable strap 200. The side straps 190 can further comprise a length adjusting mechanism (not shown). In an alternate embodiment as illustrated in FIG. 9, the wound protection system for the front legs can be used without the loop 195 through which the collar is passed. The use of the same reference numeral denotes the same part. A length adjusting mechanism 205 is used to adjust the side strap 190a. The interlocking mechanism 210 connects the ends of the side strap 190a from either side.

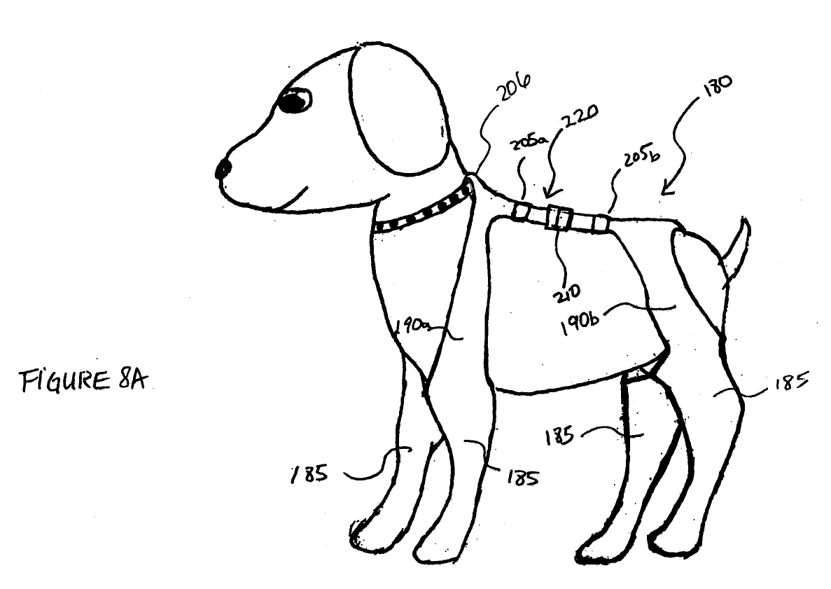

FIG. 8 illustrates the use of one embodiment of the wound protection system on all four limbs. The side straps 190a, 190b from each tubular sheath 185 extend upwards towards the back of the animal wherein the side straps 190a, 190b merge with the adjustable strap 220. Adjustable strap 220 comprises an interlocking mechanism for connecting the front set of side straps 190a to the back set of side straps 190b. Adjustable strap 220 further comprises interlocking mechanisms 205a and interlocking mechanisms 205b which can individually or in combination adjust the length of the adjustable strap 220. FIG. 8A illustrates that a loop 206 can be used to secure the wound protection system to an animal's collar.

The wound protection system is not limited to use only when an animal is injured. The wound protection system can also be used to prevent an animal's limb from contact with mud or salt, such as during the winter seasons when salt is put on the road.

Straps, tubular sheathing, and paw regions can be made from the same or different material, depending on various factors including the fluid permeability of the material, the weight of the material, the type and location of the wound, and the type of animal. The tubular sheathing can be made of elasticized material to allow for comfortable wear and movement of the animal's limbs. The material for the tubular sheathing preferably has characteristics that allow the sheath to be laterally stretchable with minimal longitudinal stretchability. The material may also be gas permeable to allow the portions of the animal's limb which are covered by the wound protection system to breath. Numerous suitable materials known to one skilled in the art can be used to address the aforementioned considerations. The adjustable straps may be made from a material exhibiting elastic characteristics.

From the foregoing, it will be observed that numerous variations and modifications may be effected without departing from the spirit and scope of the invention. It is to be understood that no limitation with respect to the specific apparatus illustrated herein is intended or should be inferred.

All references, including publications, patent applications, and patents, cited herein are hereby incorporated by reference to the same extent as if each reference were individually and specifically indicated to be incorporated by reference and were set forth in its entirety herein.

1. A wound protection system for an animal's limb comprising:
a tubular sheath configured to fit over an animal's limb;
an adjustable strap extending from the tubular sheath and configured to be hung from the animal, wherein the adjustable strap is capable of exerting an upward force on the tubular sheath.

2. The wound protection system of claim 1, wherein the adjustable strap comprises a loop and an adjustment mechanism.

3. The wound protection system of claim 2, wherein the loop is at a distal end of the strap.

4. The wound protection system of claim 2, wherein the loop is adjustable in size.

5. The wound protection system of claim 4, further comprising an adjustment mechanism and an interlocking mechanism.

6. The wound protection system of claim 1, wherein the tubular sheath extends to and encloses the animal's paw.

7. The wound protection system of claim 1, further comprising a fitted portion.

8. The wound protection system of claim 1, further comprising a paw region.

9. The wound protection system of claim 1, further comprising a plurality of reinforcing ribs.

10. The wound protection system of claim 1, further comprising at least one padding sleeve to receive a padding insert.

11. The wound protection system of claim 1, wherein at least a portion of either the adjustable strap or the tubular sheath is made from an elastic material.

12. The wound protection system of claim 1, wherein at least a portion of the tubular sheath is made from a water resistant material.

13. The wound protection system of claim 1, further comprising a height-adjustment mechanism.

14. The wound protection system of claim 1, further comprising a non-stretchable strip.

15. The wound protection system of claim 14, wherein the non-stretechable strip is disposed lengthwise along the inner surface of the tubular sheath.

16. A wound protection system to cover an animal's limbs comprising:
a pair of tubular sheaths with side straps which extend and converge with the opposing side strap.

17. The wound protection system of claim 16, further comprising an interlocking mechanism at the convergence of opposing side straps.

18. The wound protection system of claim 16, further comprising an adjustment mechanism on the side straps.

19. The wound protection system of claim 16, wherein the convergence of opposing side straps form a T-shaped intersection with at least a portion of an adjustment strap.

20. The wound protection system of claim 16, wherein the pair of tubular sheaths are connected by an interlocking mechanism along the adjustment straps.
